(19) United States
(12) Patent Application Publication
(10) Pub. No.: US 2025/0087114 A1
(43) Pub. Date: Mar. 13, 2025

(54) METHOD FOR PRODUCING A MEDICAL SIMULATOR, MEDICAL SIMULATOR AND USE OF A MEDICAL SIMULATOR

(71) Applicant: SKZ - KFE gGmbH, Würzburg (DE)

(72) Inventors: Thomas HOCHREIN, Rimpar (DE); Irena HEUZEROTH, Rimpar (DE); Peter KRANKE, Höchberg (DE)

(21) Appl. No.: 18/260,516

(22) PCT Filed: Jan. 11, 2022
(86) PCT No.: PCT/EP2022/050409

§ 371 Date: Jul. 6, 2023

(30) Foreign Application Priority Data
Jan. 15, 2021 (DE) 10 2021 200 362.1

(51) Int. Cl. G09B 23/28; B33Y 80/00

(52) U.S. Cl. CPC G09B 23/285; B33Y 80/00

(57) ABSTRACT

A method for producing a medical simulator is described. A first foam component of the medical simulator is additively manufactured. At least one further foam component of the medical simulator is additively manufactured. The foam components are manufactured so as to have different foam structures and/or from different materials. A medical simulator and a use of a medical simulator are also described.

### CROSS-REFERENCES TO RELATED APPLICATIONS

This application claims the priority of German Patent Application, Serial No. DE 10 2021 200 362.1, filed Jan. 15, 2021, the content of which is incorporated herein by reference in its entirety as if fully set forth herein.

### FIELD OF THE INVENTION

The invention relates to a method for producing a medical simulator and to a medical simulator. In particular, the medical simulator may be an epidural anaesthesia simulator. The invention further relates to the use of a medical simulator for training medical staff.

### BACKGROUND OF THE INVENTION

Medical simulators are known from the prior art. Medical simulators simulate body parts and/or characteristics of a patient, in particular a human patient. They are used to simulate a medical treatment, in particular to train medical staff therefor. For example, injections can be simulated and trained. One example of this is epidural anaesthesia, in which it is important to inject an anaesthetic into the epidural space at an exact location.

### SUMMARY OF THE INVENTION

It is an object of the present invention to provide an improved method for producing a medical simulator, and in particular to provide a method which allows flexible and accurate adjustment of the characteristics and/or tissue structures to be simulated.

This object is achieved by a method for producing a medical simulator comprising the steps of additive manufacturing of a first foam component and additive manufacturing of at least one further foam component, wherein the first foam component and the at least one further foam component are manufactured so as to have different foam structures and/or from different materials. The manufactured medical simulator therefore has at least two foam components. Foam components have proven to be particularly suitable for reproducing tissue structures of a body. The manufactured medical simulator may in particular be an epidural anaesthesia simulator.

The essence of the method according to the invention is the additive manufacturing of the first foam component and the at least one further foam component. The additive manufacturing of the foam components has the advantage that the material, geometry and characteristics of the foam components can be specifically determined. It is also advantageous that the various foam components can be manufactured in a simple manner so as to have different characteristics, namely different foam structures and/or different materials. This means that different foam structures can be realized, in particular in a small space. With the help of the different characteristics, body characteristics to be simulated, in particular tissue structures, can be adjusted and varied in a targeted manner. The body characteristics to be simulated, in particular tissue structures, can be varied, for example continuously varied, in particular on small spatial scales. With the help of the additively manufactured at least two foam components, various tissue types can be simulated in the medical simulator.

With the help of the method, a needle penetration resistance and/or a fluid penetration resistance of the respective foam components can be adjusted and varied in a targeted manner. The needle penetration resistance is the resistance that a tissue offers to the hypodermic needle. The fluid penetration resistance is the resistance that a tissue offers to the fluid to be injected. The fluid penetration resistance can be sensed, for example, by the plunger resistance of a fluid-filled syringe placed on the hypodermic needle. The fluid penetration behaviour is particularly relevant for the injection of medicines, in particular the injection of an anaesthetic. Based on the fluid penetration resistance, two tissue types in particular can be distinguished that have essentially the same needle penetration resistance. The needle penetration resistance and the fluid penetration resistance are important orientation aids for the precise placement of a hypodermic needle and the injection. The simulator manufactured according to the invention is particularly well suited for training of location-accurate injections. In particular, the simulator manufactured in such a manner is suitable as an epidural anaesthesia simulator. Preferably, various needle penetration resistances as well as various fluid penetration resistances are simulated. Other types of medical simulators also benefit from the precise adjustability and variability of the additively manufactured at least two foam components.

Another advantage of the method is that the expansion of the additively manufactured foam components can be adjusted in a targeted and precise manner. In particular, variations of the foam structures and/or the materials can be made in a small space. This enables a more precise and flexible simulation of various tissue structures.

The medical simulator manufactured according to the invention has at least two foam components. The method may include additive manufacturing of any number of foam components. For example, three, in particular four, in particular five, preferably more than five foam components can be additively manufactured. The medical simulator may have in particular three, in particular four, in particular five, preferably more than five foam components. The foam components may alternately have different foam structures and/or different materials. However, it is also possible that individual foam components are manufactured having the same foam structure and/or from the same material.

For the purpose of the invention, a foam component means in particular components which comprise a solid foam. Solid foam consists of a foam structure of solid material with gas inclusions, in particular air inclusions. The foam structure has in particular gas-filled elementary cells of solid material. This includes in particular elastically deformable foams and also only plastically deformable foams. The elasticity and deformability of the foams can be influenced, for example, by the material and/or the foam structure.

In addition to the additively manufactured at least two foam components, the medical simulator may also have one or more other components that are not configured as foam components. For example, full-volume components can be manufactured. Here and in the following, full-volume components are to be understood as components that are made of a solid material, i.e., have essentially no gas inclusions. For example, full-volume components can be used to simulate bone structures and/or skin. The other components can also be additively manufactured. Alternatively, the further components may be manufactured otherwise. Components that have been manufactured otherwise can be subsequently joined to the additively manufactured foam components. If the term component is used here and in the following without further additions, this should be understood such that the corresponding component is either a foam component or another component, in particular a full-volume component.

The production including different foam structures is to be understood such that the respective foam components differ in at least one foam structure parameter that defines the foam structure of the foam component. Such foam structure parameters are in particular the geometry of the elementary cells, the orientation of the elementary cells, the average size of the elementary cells, the foam density, the thickness of the cell wall structures and/or the pore structure. With the help of additive manufacturing, the respective foam structure parameters can be adjusted in a targeted manner. The foam structure parameters of the additively manufactured foam components are in particular not limited to foam structures of natural or otherwise produced foams.

For example, the foam structure parameter relating to the geometry of the elementary cells can determine whether the elementary cells that form the foam structure have the same or different geometries. For example, the foam structure elementary cells may have a fixedly predetermined geometry, such as a cubic, hexagonal or spherical geometry. Alternatively, the elementary cells of one foam structure may also have different geometries. For example, different geometries can be combined in a targeted manner. Irregular geometries are also possible. In particular, the elementary cells can have any different geometries.

The foam structure parameter that relates to the orientation of the elementary cells is particularly relevant if the foam structure elementary cells have a greater extension in at least one spatial direction than in another spatial direction. The spatial direction of greatest extension is also referred to as the main extension direction. The main extension directions of the elementary cells may be randomly distributed. Alternatively, the elementary cells can also have a common main direction of extension. As a result, laminar structures can be produced, for example. In particular, flow paths of a medium to be injected can be adjusted in a targeted manner.

The average size of the elementary cells is determined in particular by their extension, especially length, along the main extension direction of the elementary cells. The length along the main extension direction is also referred to as the main extension. The elementary cells of a foam component can each have the same main extension. The average size of the elementary cells then corresponds to the main extension of each of the elementary cells. Otherwise, the average size may be determined by averaging the size of the elementary cells, in particular their main extension. For example, the average size of the elementary cells may be between 1 μm and 2 mm, in particular between 50 μm and 1 mm, preferably between 100 μm and 500 μm. The average size of the elementary cells has an influence in particular on the structural sizes of the respective foam component. The average size of the elementary cells has in particular an influence on the fluid absorption capacity of the respective elementary cells and thus on a fluid absorption behaviour of the respective tissue structure to be simulated.

In principle, the foam components can be manufactured so as to have any geometries, orientations and/or sizes of the elementary cells. However, the respective foam structure parameters can also influence each other. For example, the influence of the geometry of the elementary cells decreases as the average size of the elementary cells decreases. This is especially the case when an injection is to be simulated and the average size of the elementary cells is smaller than a typical needle diameter. In such a case, the geometry of the elementary cells is no longer sensed by the needle during piercing. In such a case, the geometry of the elementary cells has only little influence on needle penetration resistance. However, the geometry and orientation of the elementary cells can have a large influence on the fluid penetration resistance even with small average sizes of the elementary cells. For example, a laminar structure can be produced by a specific alignment of the elementary cells, which can be used, for example, to control flow paths in the foam structure. As a result, a lower fluid penetration resistance can be simulated even with small average sizes of the elementary cells. A rod structure is also possible. In particular, the geometry of the elementary cells is adjustable by a rod diameter, a rod length and/or the branching structure of the rod structure. Rod diameter, rod length and/or branching structure can in particular be determined variably and flexibly.

The foam density is determined in particular by the porosity. Porosity is defined as a ratio of void volume to total volume of the foam structure. The porosity therefore indicates a ratio of material to gas, in particular material to air, in the foam structure. The foam has pockets of gas. The total volume of the foam component is therefore divided between the volume filled by the material forming the elementary cell structure and the volume filled by the gas inclusions, in particular air inclusions. The proportion of the material in the available total volume can be, for example, between 1% and 99%, in particular between 5% and 50%, preferably between 10% and 30%. The aforementioned percentages are in particular percentages by volume. The greater the proportion of material, the greater the needle penetration resistance and fluid penetration resistance of the foam component.

The thickness of the cell wall structures is determined in particular by the wall thickness of the cell walls. This influences in particular how stable the respective elementary cells and thus the foam structure are. The thickness of the cell wall structures can also influence the foam density. The thickness of the cell wall structures in particular affects a needle penetration resistance. For example, the wall thickness of the cell walls can influence the needle penetration resistance.

The pore structure is determined in particular by the size and number of open interconnection points between individual elementary cells. Open interconnection points between the elementary cells allow an exchange of media, in particular an exchange of fluids, between the elementary cells. Open interconnection points are also referred to as pores here and in the following. Open interconnection points can be formed by through-openings in the cell walls. Open interconnection points can also be formed by missing cell walls. This may be the case in particular if the foam structure is manufactured in the form of a rod structure. If the cell walls do not have any open interconnection points, i.e. no pores, the foam structure is closed-cell or closed-pored. In this case, media exchange, in particular fluid exchange, between individual elementary cells is prevented. However, it is possible that a media pressure, in particular a fluid pressure, is so high that the cell walls are broken through. The more open interconnection points or pores there are between the elementary cells, the more fluid can pass from one of the elementary cells into the next one. If such open interconnection points or pores are present between the elementary cells, this is referred to as an open-pored or open-cell foam structure. The pore structure is determined in particular by a ratio of open-pored to closed-pored elementary cells. The foam structure parameter of the pore structure can be used in particular to adjust a fluid penetration resistance and a fluid absorption behaviour of the foam structure.

The material that is used to manufacture the foam component may in particular be a base material to which at least one additive is added. Differences in the material may therefore relate to the base material and/or to the at least one additive.

The base material may in particular be a polymer. Suitable base materials are, for example, polyolefins, polyesters, polyethers, polyoxymethylenes, polyureas, polyimides, polyurethanes, polyamides and/or silicones. Advantageous base materials are, for example, polypropylene (PP), polyethylene (PE), polylactides (PLA), polyamide 12 (PA12), polyurethanes (PU), silicones, polyoxymethylene (POM), polyethylene terephthalate (PET), poly-sulphones (PES), polybutylene terephthalate (PBT) and/or thermoplastic elastomers (TPE). Suitable thermoplastic elastomers (TPE) include, for example, thermoplastic polyamide elastomers (TPA), olefin-based thermoplastic elastomers (TPO), thermoplastic styrene copolymers (TPS), urethane-based thermoplastic elastomers (TPU), thermoplastic vulcanisates (TPV) and/or unclassified thermoplastic elastomers of any other composition or structure than the aforementioned (TPZ). Depending on the base material, in particular a strength of the respective foam structure can be adjustable. As a result, the needle penetration resistance in particular can be influenced.

The at least one additive can be used, for example, to adjust a coefficient of friction of the material. As a result, in particular, a coefficient of friction between a hypodermic needle and the foam component can be adjusted. This has an influence in particular on the needle penetration resistance.

Preferably, the at least one additive is a triboadditive. Suitable triboadditives are in particular molybdenum disulphide, polytetrafluoroethylene (PTFE), waxes and/or oils, in particular fluorinated oils.

Alternatively or additionally, the at least one additive may also contain a plasticizer. This can be used in particular to adjust the flexibility of the foam structure.

The needle penetration resistance can, for example, be achieved by the use of a suitable base material, in particular the use of a base material of suitable hardness, and/or the additivation of the base material, in particular the additivation of the base material by means of triboadditives. In addition or alternatively, the needle penetration resistance can be adjusted in particular via the geometry of the elementary cells, the orientation of the elementary cells, the average size of the elementary cells, the thickness of the cell wall structures and/or the foam density, in particular the porosity of the foam structure.

The following foam structure parameters have proven to be particularly suitable for adjusting the fluid penetration resistance: The geometry of the elementary cells, the orientation of the elementary cells, the average size of the elementary cells, the foam density, in particular the porosity of the foam structure, and the pore structure, in particular the size and number of open interconnection points or pores between the elementary cells.

Any additive manufacturing methods can be used to produce the at least two foam components. Selective laser sintering (LS), electron beam melting (EBM) or electron beam additive manufacturing (EBAM), stereolithography (SL) and/or digital light processing (DLP) have proven to be particularly suitable. Preferably, the additive manufacturing of the foam components can be carried out by means of fused filament fabrication (FFF), multijet modelling (MJM) and/or Arburg plastic freeforming (AKF). FFF and AKF have proven to be particularly suitable for processing various materials.

The manufacture of the at least two foam components may be such that the size and shape of the respective foam component is specified. The size and shape of the foam component can correspond to the size and shape of a corresponding tissue in a body. The foam structure of the respective foam component can then be automatically generated by means of standardized filling patterns, in particular with the aid of CAD software. In doing so, the materials to be used, in particular a base material to be used and/or at least one additive, and/or foam structure parameters to be used can be predetermined. On the basis of the predetermined materials and foam structure parameters, a suitable filling pattern for the foam component can then be determined automatically by means of a computer program. Alternatively, in addition to the size and shape of the foam components, the elementary cell structure can also be precisely predetermined. This is particularly advantageous if certain structures are to be used to achieve a specific fluid flow behaviour. The specification of the size and shape of the foam components and/or the respective foam structures can be done in particular with the aid of CAD programs. The corresponding CAD models can then be printed out using a suitable 3D printer for additive manufacturing of the at least two foam components.

The additive manufacturing of the at least two foam components and, if applicable, further components of the medical simulator does not necessarily take place sequentially. In particular, different additively manufactured components of the medical simulator are not manufactured one after the other. Rather, different components of the medical simulator can be manufactured in parallel. For example, many additive manufacturing methods use layer-by-layer manufacturing. In this case, the medical simulator will be manufactured in layers. In doing so, the layers of different components, in particular foam components, located in one manufacturing layer are manufactured in parallel before further layers of the respective components are manufactured. Individual layers of different components are therefore manufactured for each manufacturing layer.

A method in which at least one of the at least two foam components is manufactured so as to have a predetermined geometry of the elementary cells, orientation of the elementary cells, size of the elementary cells and/or cell wall structure, in particular so as to have a predetermined orientation of the elementary cells and/or size of the elementary cells enables a particularly effective and targeted setting of characteristics to be simulated, in particular of the fluid penetration behaviour. Through the targeted specification of the geometry of the elementary cells, the orientation of the elementary cells, the size of the elementary cells and/or the cell wall structure, the characteristics of the simulator can already be influenced at the level of the elementary cells. These parameters can be specified using CAD programs, for example. The predefined elementary cell structures can then be specifically printed out, for example, using a 3D printer. In particular, the cell wall structures can be specifically printed in order to precisely define the elementary cell structure.

Preferably, the at least two foam components are manufactured so as to have a predetermined geometry of the elementary cells, orientation of the elementary cells, size of the elementary cells and/or cell wall structure, in particular so as to have a predetermined orientation of the elementary cells and/or size of the elementary cells.

A method, in which the first foam component and the at least one further foam component are manufactured so as to have different foam structures, wherein the different foam structures differ by at least one of the following foam structure parameters: geometry of the elementary cells, orientation of the elementary cells, average size of the elementary cells, pore structure and foam density, in particular porosity, enables a particularly effective and targeted adjustment of the fluid penetration behaviour. For a targeted placement of the injection, in particular for epidural anaesthesia, the physician has to rely on knowing the fluid penetration resistance in the respective tissue layers of the patient. With the help of the corresponding additively manufactured medical simulator, realistic fluid penetration resistances and their variations across various tissue types can be simulated in a simple and reliable manner.

A method, in which the first foam component and the at least one further foam component are manufactured from the same base material, in particular from the same base polymer, with different additivation in each case, enables a particularly simple and efficient change of the material characteristics of the at least two foam components during additive manufacturing. It is not necessary to exchange the base material, in particular the base polymer. In particular, the same feedstock can be used for the manufacture of the at least two foam components. The additivation can take place during the additive manufacture, for example through another nozzle of a 3D printer. This simplifies the manufacturing method and increases its efficiency. With the help of the different additivation, the material parameters can be adjusted in a simple manner. In particular, a hardness and/or a coefficient of friction of the respective material can be adjusted.

A method comprising additive manufacturing of a transition region between two adjacent foam components, wherein the transition region comprises a gradual transition between the different foam structures and/or materials of the adjacent foam components, allows the production of a particularly realistic medical simulator. The additively manufactured transition region has in particular a foam structure comprising a gradual transition between at least one different foam structure parameter of the adjacent foam components. In particular, a gradual adjustment of different foam structure parameters of adjacent foam components takes place via the transition region. In addition or alternatively, a material mixture and/or additivation of the adjacent foam components can be gradually adjusted in the at least one transition region. The gradual adjustment is to be understood as a stepwise adjustment, in particular a stepwise variation of the foam structure parameters. The gradual adjustment is preferably carried out on the size scale of individual elementary cells of the transition region. Advantageously, smooth transitions between different foam components, in particular between their different foam structures, can be created with the aid of the additively manufactured transition region. Abrupt transitions between the foam components are avoided. This allows realistic transitions between different tissue types to be simulated. Unrealistic, harsh transitions between the foam components and in particular the body characteristics that are simulated thereby are avoided.

For example, a first foam component may consist of a material A and a second, adjacent foam component may consist of a material B. In the transition region, starting from the foam component made of material A, more and more proportions of material B are then gradually mixed into a material used to manufacture the transition region. In particular, a proportion of a suitable additive can be gradually increased or decreased. Accordingly, a gradual adjustment of at least one different foam structure parameter may be performed. For example, one of the foam components may be closed-cell or closed-pored. The second, adjacent foam component can be open-pored. In the transition region, the number and/or size of the pores that connect the elementary cells can be gradually increased.

A method in which the at least two foam components are manufactured integrally enables efficient manufacturing as well as a particularly realistic medical simulator. The integral manufacture of the at least two foam components can lead in particular to a one-piece design of the two foam components and any possible transition regions. Subsequent joining of different foam components is avoided. In particular, this means that it is not necessary to provide joining connections between the foam components and/or the transition regions. Such joining connections, for example adhesive layers, may have an adverse effect on the characteristics of the medical simulator. In particular, they may cause characteristics that are not present in the tissue to be simulated. For example, a joining connection may result in a locally greatly increased needle penetration resistance, which does not occur as such in the corresponding tissue structures of a patient.

Particularly preferably, the entire medical simulator is integrally manufactured. All components of the medical simulator, in particular also full-volume components, can be integrally additively manufactured. The medical simulator can be designed in one piece as a whole. Subsequent joining of different components of the medical simulator is consistently avoided. An additively manufactured medical simulator as a whole reproduces the characteristics of grown tissue structures particularly accurately.

A method in which at least one of the foam components is manufactured so as to have a foam structure in the form of a rod structure, wherein the edges of the elementary cells are formed by rods, allows the manufacture of a medical simulator which has a high fluid absorption capacity, in particular with simultaneous high structural strength. With the aid of the rod structure, in particular only the edges of the elementary cells are reproduced. Cell walls between the edges formed by rods can be partially or completely omitted. This creates a particularly large pore structure between the elementary cells. The resulting foam density is very low. The fluid absorption capacity is greatly increased. The fluid penetration resistance is very low. At the same time, high strengths of the foam structure can be achieved by producing stiff rod structures. With the aid of the rod structure, a low fluid penetration resistance with simultaneous high needle penetration resistance can be simulated. Such rod structures differ significantly from natural or otherwise manufactured foams.

A method in which the at least two foam components are adapted to a tissue structure of a patient enables the manufacture of a medical simulator that is particularly adapted to a patient and/or simulation purpose. The adaptation to a patient may be performed generally to a specific type of patient, for example to patients of various stature and/or weight. Preferably, the at least two foam components, in particular the entire medical simulator, are adapted to a specific patient. In this way, complicated medical procedures can be reliably practised with the aid of the medical simulator. In particular, the tissue structures that are relevant for epidural anaesthesia and their respective extension can depend considerably on the respective stature of a patient. The adaptation of the at least two foam components, in particular of the medical simulator as a whole, to a patient can, for example, be carried out such that a tissue structure of the patient to be simulated is captured by means of imaging methods. The captured tissue structure can then be transferred into a corresponding structure of at least two foam components using suitable methods. The resulting structure may have at least two foam components and at least one full-volume component. In particular, computer tomography (CT) or magnetic resonance imaging (MRI) can be used as an imaging method. With these, various soft tissue layers, which can be simulated particularly well by the additively manufactured foams, can be captured.

It is another object of the invention to provide an improved medical simulator, in particular to provide a medical simulator that specifically simulates various characteristics of the tissue structure of a patient, in particular various needle penetration resistances and/or fluid penetration resistances, reliably and accurately.

This object is achieved by a medical simulator, in particular an epidural anaesthesia simulator, having at least two additively manufactured foam components, wherein the foam components differ in at least one of the following features: foam structure and material. As described with regard to the method, a targeted and effective adaptation of the characteristics of the foam structures to characteristics of tissue types to be simulated can be achieved on the basis of the suitable selection of the differences in the foam structure, in particular individual foam structure parameters, and/or the material.

The medical simulator may also have more than two foam components. For example, the medical simulator may have three, in particular four, in particular five, in particular more than five, foam components. The foam components of the medical simulator can each be designed differently. Individual ones of the foam components may also comprise the same material and/or the same foam structure. Various foam components may, for example, have been additively manufactured from the same material but with different manufacturing parameters, in particular different pressure parameters. The medical simulator is in particular an epidural anaesthesia simulator. The medical simulator has in particular the features and advantages that have been discussed in connection with the manufacturing process.

A medical simulator configured such that the foam structures of the first foam component and of the at least one further foam component differ by at least one of the following foam structure parameters: geometry of the elementary cells, orientation of the elementary cells, average size of the elementary cells, pore structure and foam density, in particular porosity, is particularly suitable for simulating various fluid penetration resistances. The medical simulator is particularly suitable for simulating injection behaviour, in particular targeted injection into specific tissue parts. This is especially advantageous for an epidural anaesthesia simulator.

A medical simulator configured such that the first foam component and the at least one further foam component have the same base material, in particular the same base polymer, with different additivation in each case, is manufacturable in a simple and efficient manner. The at least two foam components of the medical simulator have in particular two specifically adjustable different needle penetration resistances.

A medical simulator comprising a transition region between two adjacent foam components, wherein the transition region comprises a gradual transition between the different foam structures and/or materials of the adjacent foam components, is particularly suitable for simulating real tissue structures. Unnaturally harsh transitions between different foam components which simulate different tissue types are avoided. By means of the transition region, a smooth transition between different tissue types is realistically reproduced.

A medical simulator configured such that at least one of the different foam structures has a rod structure, wherein the edges of the elementary cells are formed by rods, has a high fluid absorption capacity while having high structural stability at the same time. With the aid of the rod structure, in particular only the edges of the elementary cells are simulated. Cell walls between the edges can be partially or completely omitted. This allows high needle penetration resistance to be combined with low fluid penetration resistance.

A medical simulator configured such that the at least two foam components are formed in one piece can be manufactured particularly efficiently and has high stability. Another advantage is that a one-piece simulator reproduces a grown tissue structure particularly realistically. Subsequent joining of different foam components is avoided. Joining layers, for example adhesive layers, which lead to unnatural characteristics, are avoided. Particularly preferably, the entire medical simulator is formed in one piece. In particular, the entire medical simulator can be integrally additively manufactured.

A medical simulator configured such that at least one of the at least two foam components has a predetermined geometry of the elementary cells, orientation of the elementary cells, size of the elementary cells and/or cell wall structure, in particular a predetermined orientation of the elementary cells and/or size of the elementary cells, enables a particularly effective and targeted setting of characteristics to be simulated, in particular the fluid penetration behaviour. The characteristics of the simulator are already influenced at the level of the elementary cells by the specifically predetermined geometry of the elementary cells, orientation of the elementary cells, size of the elementary cells and/or cell wall structure. The elementary cell structure, in particular the geometry and/or orientation of the individual elementary cells, is precisely specified. For example, the elementary cells have a cubic, hexagonal or spherical geometry. Alternatively, the elementary cells of a foam structure may also have different geometries. For example, different geometries can be combined in a targeted manner. Irregular geometries are also possible. In particular, the elementary cells can have any different geometries.

Preferably, the at least two foam components have a predetermined geometry of the elementary cells, orientation of the elementary cells, size of the elementary cells and/or cell wall structure, in particular a predetermined orientation of the elementary cells and/or size of the elementary cells.

It is a further object of the invention to improve training of medical staff with the aid of a medical simulator.

This object is achieved by the use of a medical simulator according to the previous description, according to which the medical simulator described above is used for training medical staff. Advantageously, training can be carried out with a medical simulator whose characteristics are precisely adapted to the characteristics of natural tissue. In particular, the training may concern the injection of medicines, especially an anaesthetic. In particular, the medical simulator can be used to simulate and train epidural anaesthesia. The advantages resulting therefrom are the same as those described above in connection with the manufacturing method and the medical simulator.

A use in which different needle penetration resistances and different fluid penetration resistances are simulated by means of the at least two foam components is particularly suitable for training with regard to pinpoint injections, in particular with regard to epidural anaesthesia. Needle penetration resistance and fluid penetration resistance are two essential parameters by which the positioning of a hypodermic needle in a patient's tissue can be determined. By using various foam components, which differ at least in their foam structure and/or material, these essential characteristics can be reproduced realistically.

Preferably, the training can be performed using a simulator that has been adapted to a patient. Particularly preferably, the simulator used for training is adapted to the tissue structure of a specific patient. For example, the tissue structure of a specific patient can be recorded using imaging methods and converted into corresponding foam structures using suitable programs. The corresponding foam components that have been adapted to the patient's tissue can then be manufactured in a targeted manner using additive manufacturing.

Further features, advantages and details of the invention can be seen from the following description of preferred embodiments based on the figures.

### BRIEF DESCRIPTION OF THE FIGURES

FIG. 1 shows a schematic illustration of a longitudinal section through a tissue structure of a human being and a medical simulator that reproduces the corresponding tissue structure,

FIG. 2 shows a schematic illustration of two different foam components of the medical simulator according to FIG. 1 and an intermediate transition region,

FIG. 3 shows a schematic process flow for the manufacture of a medical simulator and

FIG. 4 shows two foam components which are additively manufactured in the form of a rod structure.

### DESCRIPTION OF THE PREFERRED EMBODIMENTS

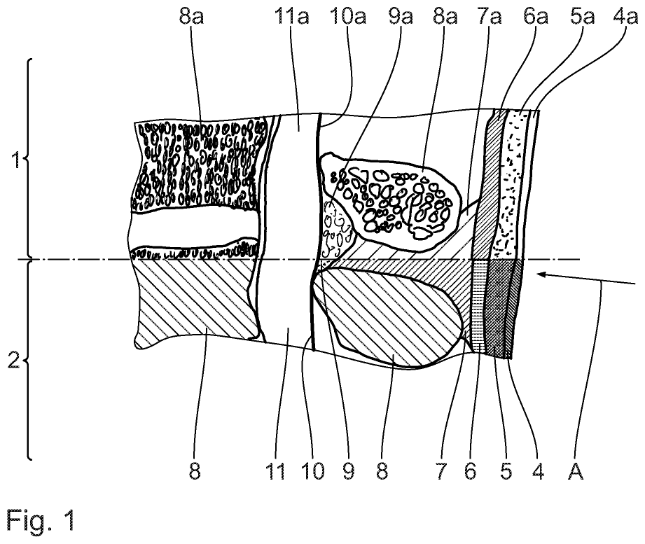

The upper half of FIG. 1 schematically shows a longitudinal section through the tissue structure 1 of a patient in the region of the spinal column. The lower half of FIG. 1 schematically shows a longitudinal section through a medical simulator 2 that has been adapted to the tissue structure 1 of the patient. For the respective tissue types of the tissue structure 1, the same reference signs are used in the following as for the corresponding components of the medical simulator 2, but the letter a is added.

In the following, the different tissue types of the tissue structure 1 are described from the outside to the inside. The skin 4a comprises the epidermis, the dermis and the subcutis. This is followed by fatty tissue 5a and muscle tissue 6a. This is followed by the ligament 7a. The vertebrae of the spinal column are made of bone 8a. A vertebral canal is formed between the vertebrae, which comprises the dura mater 10a and the cerebrospinal fluid space 11a. Between the vertebral processes and the dura mater 10a there is the epidural space 9a.

During epidural anaesthesia, the anaesthetic must be injected into the epidural space 9a. Here it is enormously important that the physician stops advancing the needle in time when reaching the correct position in order to introduce the anaesthetic into the epidural space 9a. In FIG. 1, arrow A shows an exemplary injection direction for the insertion of the needle. In epidural anaesthesia, the physician must deduce the correct positioning of the needle from the penetration depth, the needle penetration resistance N and the fluid penetration resistance F. Since the different tissue types 4a to 11a have different needle penetration resistances N and/or fluid penetration resistances F, the trained physician can position the hypodermic needle accordingly on the basis of these parameters.

The medical simulator 2 is an epidural anaesthesia simulator. The medical simulator 2 is additively manufactured and has a plurality of components 4 to 11 which correspond in size and shape to the respective tissues 4a to 11a. The various components 4 to 11 of the medical simulator 2 are configured to be foam components or full-volume components.

The different components 4 to 11 are each made of a polymer. The components 8 that reproduce the bones 8a are made of a polymer as full-volume components. This reproduces the extremely high needle penetration resistance N and fluid penetration resistance F of the bones 8a. The component 4 that simulates the skin 4a is also a full-volume component. Also, the component 10 that replicates the dura mater 10a may be a full-volume component. The remaining components 5 to 7, 9 and 11 are configured to be foam components. The component 10 that replicates the dura mater 10a can also be designed as a foam component.

To simulate different needle penetration resistances N and fluid penetration resistances F, the components 4 to 11 differ at least in their foam structure and/or in their material. By specifically adapting the foam structures and/or the material, the components 4 to 11 have fluid penetration resistances F and needle penetration resistances N that correspond to those of the corresponding tissues 4a to 11a.

Differences in the material can be created by the polymer used in each case. However, it is also possible to use different additives with the same base polymer. For example, the hardness of the material can be adjusted by using different plasticizers. Furthermore, different foam components can have triboadditives to adjust a frictional resistance between the foam structure and a needle.

With regard to the foam structure, differences in the following foam structure parameters are possible in particular: geometry of the elementary cells, orientation of the elementary cells, average size of the elementary cells, foam density, thickness of the cell wall structures and/or pore structure.

The following parameters in particular have proven to be suitable for adjusting the needle penetration resistance: geometry and orientation of the elementary cells, thickness of the cell wall structures, average size of the elementary cells, foam density, base polymer used and/or additivation of the base polymer. The following parameters in particular have proven to be suitable for adjusting the fluid penetration resistance: geometry of the elementary cells, orientation of the elementary cells, average size of the elementary cells, pore structure and foam density, in particular the porosity of the foam structure.

Table 1 lists the different tissue types with regard to their needle penetration resistances N and fluid penetration resistances F. In addition, possible designs of the corresponding components 4 to 11 of the medical simulator 2 and the respective materials used are indicated.

TABLE 1
Assignment of the needle penetration resistances N and fluid penetration resistances
F to the different tissue types 4a to 11a shown in FIG. 1 and corresponding
embodiment of the components 4 to 11 of the medical simulator 2

| | | Needle | Fluid | |
|---|---|---|---|---|
| Reference | Anatomical | penetration | penetration | Foam structure |
| sign | designation | resistance | resistance | and material |
| 4a; 4 | Skin with epidermis | First high, | High | Full-volume |
| | and dermis as | then low | | component, made |
| | well as subcutis | (subcutis) | | of TPE |
| 5a; 5 | Fatty tissue | Low | Low | Open-cell, |
| | | | | comparatively small- |
| | | | | cell foam structure |
| | | | | having low |
| | | | | foam density |
| | | | | made of TPE |
| 6a; 6 | Muscle tissue | Low | Medium | Open-cell, |
| | | | | comparatively small- |
| | | | | cell foam structure |
| | | | | having higher |
| | | | | foam density |
| | | | | made of TPE |
| 7a; 7 | Ligamentum | Medium | High | Closed-cell foam |
| | (supraspinale, | | | structure having |
| | interspinale, | | | higher foam density |
| | flavum) | | | made of TPE |
| 9a; 9 | Epidural | Medium/ | Low | Open-cell foam |
| | space | Low | | structure of |
| | | | | low/medium |
| | | | | foam density |
| | | | | made of TPE |
| 10a; 10 | Dura mater | Slightly | High | Small and closed- |
| | (hard meninges) | higher than | | cell foam structure |
| | | epidural | | of higher |
| | | space | | foam density or |
| | | | | thin layer of full- |
| | | | | volume material |
| | | | | made of TPE |
| 11a; 11 | CSF space | Medium | Very low | Open-cell foam |
| | | | | structure having |
| | | | | larger average |
| | | | | size of the |
| | | | | elementary cells and |
| | | | | very low foam |
| | | | | density made of |
| | | | | TPE, alternatively |
| | | | | also designed as |
| | | | | complete cavity |
| 8a; 8 | Bones | Extremely | Extremely | Full-volume |
| | | high | high | component made of |
| | | | | TPE or a pure |
| | | | | polyolefin (PE, PP) |
| | | | | or PLA |

The embodiments of the components 2 to 11 of the medical simulator 2 mentioned in Table 1 are purely exemplary. Depending on the requirements, other foam structure parameters can be varied. It is also possible to achieve comparable needle penetration resistances N and fluid penetration resistances F by using another combination of material and foam structure. For example, other polymer materials with suitable additives can be used.

In the closed-cell foam structures mentioned in Table 1, the elementary cells of the foam structures do not have open interconnection points or pores through which fluid exchange is possible. An open-cell foam structure is characterized by such open interconnection points or pores between the elementary cells, so that a fluid exchange can take place between them. The small-cell foam structures mentioned in Table 1 are foam structures with an average size of the foam structures between 1 μm and 500 μm mm, in particular between 100 μm and 500 μm, in particular between 200 μm and 400 μm. Larger cell sizes correspond to an average size of the elementary cell between 500 μm and 2 mm, in particular between 500 μm and 1 mm. Foam structures with higher density have a material to air ratio between 40 vol % and 99 vol %, in particular between 40 vol % and 60 vol %. Foam structures with lower density have a material to air ratio between 1 vol % and 40 vol %, in particular between 5 vol % and 30 vol %.

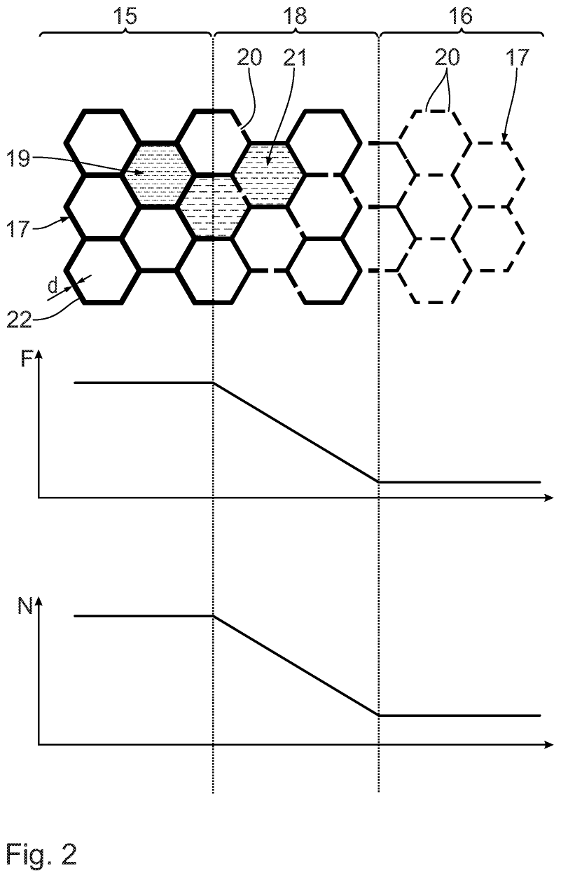

The use of different foam structures and their influence on the needle penetration resistance N and the fluid penetration resistance F are explained below with reference to FIG. 2. FIG. 2 shows an example of a first foam component 15 and a second foam component 16. Only a few elementary cells 17 are exemplarily shown for each foam component 15, 16. For reasons of clarity, only individual ones of the elementary cells 17 are provided with a reference sign in FIG. 2 as an example. The elementary cells 17 of the foam components 15, 16 are each illustrated schematically as uniform hexagons. The elementary cells 17 are each designed with the same size, geometry and orientation. The first foam component 15 can be, for example, the component 7 in FIG. 1 which simulates the ligament 7a. The second foam component 16 can be, for example, the component 6 in FIG. 1 that replicates the muscle tissue 6a.

A transition region 18 is formed between the two foam components 15, 16. The transition region 18 is additively manufactured integrally with the foam components 15, 16. As will be described in the following, a gradual adjustment between different foam structure parameters of the foam components 15, 16 takes place via the transition region 18. A sudden change in the characteristics of the different foam components 15, 16 is avoided due to the transition region 18. This simulates a smooth transition between different foam components, as is also the case in real tissue structures. In general, the transition region is dimensioned such that a transition between the adjacent foam components is possible which is adapted to the tissue structure to be replicated. As shown in FIG. 2, the transition region is usually only a few elementary cells 17 wide. In FIG. 1, corresponding transition regions are not shown for reasons of clarity.

Among the exemplarily shown foam components 15, 16 and the transition region 18, a spatial progression of the fluid penetration resistance F and the needle penetration resistance N is shown qualitatively in each case.

The foam component 15 has a foam structure with closed-cell elementary cells 17. This means that there are no open pores between the individual elementary cells 17 that would allow media exchange between the elementary cells 17. When a fluid 19 is injected into one of the elementary cells 17, the fluid 19 remains in the respective elementary cell 17. The fluid absorption capacity of the foam component 15 is therefore extremely low. The fluid penetration resistance F of the foam component 15 is high.

In the transition region 18, the number of open pores 20 between the elementary cells 17 increases gradually. For reasons of clarity, only individual ones of the open pores 20 are provided with a reference sign in FIG. 2 as an example. As the number of open pores 20 increases, the pore structure also changes, in particular a ratio of open-pore elementary cells 17 to closed-pore elementary cells 17 increases. For example, if a fluid 21 is injected into one of the elementary cells 17, the fluid 21 can spread over the corresponding elementary cell 17 and adjacent elementary cells 17. As a result, the fluid absorption capacity is increased and the fluid penetration resistance F decreases. The more elementary cells 17 are connected to each other via pores 20, the lower the fluid penetration resistance F. In the foam component 16, the elementary cells 17 each have a large number of open pores 20, so that there is only a low fluid penetration resistance F in the foam component 16. Accordingly, the qualitatively depicted fluid penetration resistance F decreases from a high value for the foam component 15 across the transition region 18 to a low value for the foam component 16.

Alternatively or in addition to the number of open pores 20 between the elementary cells 17, it is also possible to vary the fluid penetration resistance F by means of the size of the pores 20. Alternatively or additionally, the size of the elementary cells 17 can also be varied so that each elementary cell 17 can absorb more or less fluid. The foam density, in particular the porosity, can also be varied to adjust the fluid penetration resistance F. The lower the foam density, the easier it is to introduce fluid into the respective foam component 15, 16.

FIG. 2 also shows that a wall thickness d of the cell walls 22 of the elementary cells 17 gradually decreases from the foam component 15 towards the foam component 16 via the transition region 18. The strength of the respective foam structure decreases with the wall thickness d, at least if the material remains unchanged. Furthermore, if the size of the elementary cells 17 remains the same, the ratio of material to air and thus the foam density decreases. Due to the high wall thickness d in the foam structure of the foam component 15, the foam component 15 has a high needle penetration resistance N. As the wall thickness d decreases, the needle penetration resistance N decreases across the transition region 18. Due to the low wall thickness d of the cell walls 22 of the elementary cells 17 of the foam component 16, a needle penetration resistance N in the foam component 16 is low.

In addition or alternatively to the changed wall thickness d in FIG. 2, the needle penetration resistance N can be adjusted in particular by materials of different hardness. For example, different base polymers can be used for the foam components 15, 16. Additionally or alternatively, a different additivation of the base polymer can be performed. Triboadditives have proven to be particularly suitable for this purpose, as they can be used to adjust the frictional resistance between the foam structure and the needle.

In the example shown in FIG. 2, both the fluid penetration resistance F and the needle penetration resistance N are increased during the transition from the foam component 16 via the transition region 18 to the foam component 15. A corresponding increase of the fluid penetration resistance F and needle penetration resistance N is, for example, the case with a transition from muscle tissue 6a to ligament 7a (cf. FIG. 1 and Table 1). Such a transition can therefore be realistically simulated with the foam components 15, 16 and their respective foam structures shown in FIG. 2.

It goes without saying that other combinations of changing fluid penetration resistance F and needle penetration resistance N are also possible. For example, the needle penetration resistance N can be increased by increasing the wall thickness d, while at the same time a fluid penetration resistance F is reduced by providing pores 20.

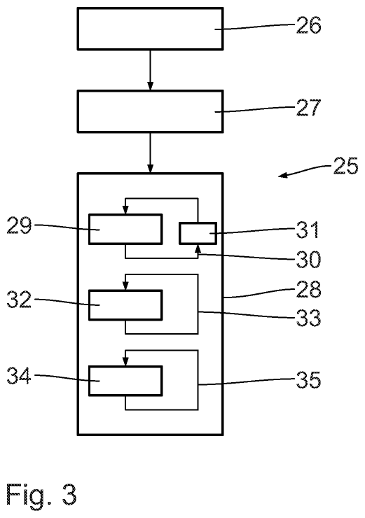

FIG. 3 schematically shows a sequence of a manufacturing method 25 for the production of a medical simulator. The manufacturing method 25 is in particular suitable for the production of the medical simulator 2.

In a capture step 26, a tissue structure which is to be recreated using the medical simulator is captured. The tissue structure can generally be the typical tissue structure of a patient. For example, average values for the tissue structure 1 shown in FIG. 1 can be used to generally determine a structure of the region of the spinal column on which an epidural anaesthesia is performed. It goes without saying that any other tissue structures can also be considered for this purpose.

Preferably, the tissue structure of a specific patient on whom an operation is to be performed is captured in the capture step 26. Based on the specific tissue structures, the medical simulator can be precisely adapted to the patient. In the present case, for example, the tissue structure of a patient can be captured with the aid of imaging methods, for example with the aid of computer tomography and/or magnetic resonance tomography. The image data obtained can then be used to calculate suitable foam components that simulate the patient's tissue structure.

The capture step 26 is followed by a foam structure determination step 27. In the foam structure determination step 27, a combination of at least two foam components is determined from the captured tissue structures that simulates the latter as accurately as possible. In the foam structure determination step 27, the structure parameters that are required for the subsequent additive manufacturing are therefore determined.

For example, the size and shape of the respective tissue types 4a to 11a of the tissue structure 1 in FIG. 1 can be predetermined in order to define the components 4 to 11 to be created in terms of their size and shape. Furthermore, a needle penetration resistance N and fluid penetration resistance F to be achieved can be determined for each of the components 4 to 11. On the basis of these parameters, for example, a computer system may determine a suitable foam structure of the respective foam components and/or suitable materials. For example, the foam structure parameters can be determined and, based on this, a suitable filling pattern for forming the foam structures can be determined automatically.

In another embodiment example, the components 4 to 11 are determined on the basis of average values of many patients with regard to their size and shape.

In yet other embodiments, a foam structure for the respective foam components can also be explicitly specified. In doing so, characteristics to be simulated can be set even more precisely. In particular, an injection behaviour, in particular the needle penetration resistance N and/or the fluid penetration resistance F, can be precisely defined. Variations of the characteristics to be simulated can also be precisely varied on small spatial scales.

The foam structure determination step 27 can be carried out in particular with the aid of a suitable design program, for example a CAD program. Generated CAD data can then be used to control a system for additive manufacturing of the medical simulator and its various components.

The foam structure determination step 27 is followed by the actual additive manufacturing 28. In the additive manufacturing 28, the various components of the medical simulator are additively manufactured. For example, components 4 to 11 of the medical simulator 2 are additively manufactured. In this case, the medical simulator as a whole is manufactured integrally. Like a grown tissue structure, the medical simulator is therefore provided in one piece. This allows real tissue characteristics to be simulated particularly realistically.

In additive manufacturing, a first foam component, for example foam component 15, is manufactured in a foam component manufacturing step 29. The foam component manufacturing step 29 is carried out at least once more in order to additively manufacture at least one further foam component, for example the foam component 16. The foam component manufacturing step 29 is performed as many times as necessary until all foam components of the medical simulator are completed. The multiple execution of the foam component manufacturing step 29 is symbolically represented by a repeat loop 30 in FIG. 3.

Between the production of different foam components, a parameter changing step 31 is carried out in which the parameters are adapted to the respective foam component to be produced. For example, a base polymer used for production and/or its additivation can also be changed in the parameter changing step 31.

The additive manufacturing 28 further comprises a transition region manufacturing step 32. In the transition region manufacturing step 32, a transition region, for example the transition region 18, is created between two adjacent foam components. The transition region manufacturing step 32 is substantially the same as the foam structure manufacturing steps 29. In particular, the transition region, for example the transition region 18, itself comprises a foam structure. The transition region manufacturing step 32 is performed until all transition regions are additively manufactured. This is shown schematically by the repeat loop 33 in FIG. 3.

The additive manufacturing 28 also includes a full-volume manufacturing step 34. The full-volume manufacturing step 34 serves to manufacture at least one full-volume component of the medical simulator. For example, the full-volume manufacturing step 34 is used to manufacture the full-volume components 8 of the medical simulator 2 that replicate the bones 8a. The full-volume manufacturing step 34 is performed until all full-volume components of the medical simulator are fully manufactured. This is shown schematically by the repeat loop 35 in FIG. 3.

It goes without saying that the individual steps of the additive manufacturing 28 are not carried out strictly sequentially, in particular not one after the other. Rather, the various steps of additive manufacturing 28 can be carried out in parallel. For example, many additive manufacturing methods use layer-by-layer manufacturing in a powder bed. In this case, the medical simulator 2 would be manufactured in layers. In doing so, for example, different layers of the components 4 to 11 of the medical simulator 2 are applied layer by layer. Individual layers of different components 4 to 11 are therefore manufactured per powder layer.

Any suitable additive manufacturing method can be used to carry out the additive manufacturing 28. Selective laser sintering (LS), electron beam melting (EBM) or electron beam additive manufacturing (EBAM), stereolithography (SL) and/or digital light processing (DLP) have proven to be particularly suitable. Preferably, the additive manufacturing of the foam components can be carried out by means of fused filament fabrication (FFF), multijet modelling (MJM) and/or Arburg plastic freeforming (AKF).

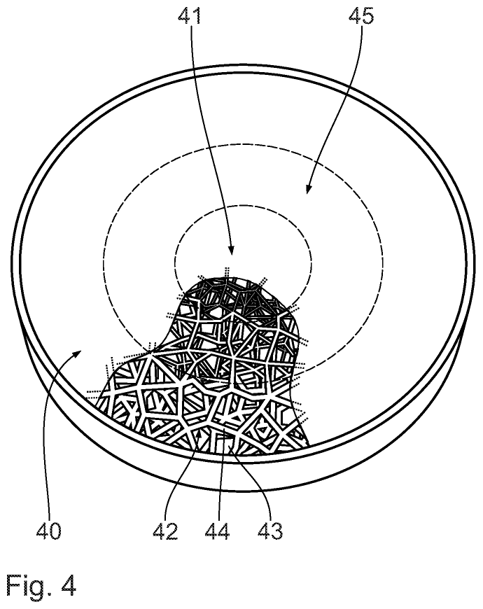

FIG. 4 shows another embodiment example of two additively manufactured foam components 40, 41 for a medical simulator. The foam component 40 can be a first foam component. The foam component 41 can be a second foam component.

The foam components 40, 41 are integrally additively manufactured from a polymer. The foam component 40 is arranged circumferentially, i.e. annularly, around the foam component 41. The boundaries of the foam components 40, 41 are each indicated with dashed circular lines. The foam components 40, 41 each have a rod structure 42. For reasons of clarity, the rod structure 42 is only shown in a section of the foam components 40, 41. The rod structure 42 is formed such that the edges of elementary cells 43 of the respective foam structures are in the form of interconnected rods 44. The elementary cells 43 have no cell walls except for the rods 44 forming the edges. The elementary cells 43 are thus fluidically interconnected. The fluid penetration resistance F of the foam components 40, 41 is thus mini-mal.

In other, not shown, embodiment examples, the fluid penetration resistance F in corresponding rod structures is increased by forming at least some of the cell walls between the rods.

The elementary cells 43 of the rod structures 42 of both foam components 40, 41 have the same average size. The elementary cells 43 have an irregular geometry. The elementary cells 43 have different, randomly distributed geometries. The only difference between the foam structures of the foam components 40, 41 is a rod diameter of the rods 44. The rod diameter of the rods 44 in the foam component 40 is substantially larger than the rod diameter of the rods 44 in the foam component 41. With the help of the rod diameter, a structural integrity of the foam components 40, 41 can be determined. The higher the rod diameter of the rods 44, the higher a needle penetration resistance N. Therefore, in the embodiment example shown in FIG. 4, the needle penetration resistance N of the foam component 40 is higher than that of the foam component 41. Due to the different rod diameter, the two foam components 40, 41 also have different foam densities.

An annular transition region 45 is formed between the foam components 40, 41. In the transition region 45, the rods 44 have a rod diameter that is smaller than the rod diameter of the rods 44 in the foam component 40 and larger than the rod diameter of the foam component 41. The rod diameter of the transition region 45 lies between the rod diameters of the rods 44 of the foam components 40, 41. This ensures a less harsh transition of the rod diameters of the two foam components 40, 41 and thus the needle penetration resistances N. In the transition region 45, the rods 44 have a uniform rod diameter. The adjustment is therefore carried out in a single step. The transition region 45 is itself formed as a foam component. In further embodiment examples, a transition region may be formed between the foam components 40, 41 in which the rod diameter gradually decreases in several steps or continuously.

In further embodiment examples not shown, the structural integrity of the foam structures may be varied alternatively or in addition to the rod diameter by the rod length and/or the branching structure and number of branches per node, i.e. the complexity of the geometry of the elementary cells 43.

With the aid of the rod structures 42, a high fluid absorption capacity, i.e. a very low fluid penetration resistance F, with simultaneous high needle penetration resistance N can be simulated. Corresponding rod structures can therefore be used, for example, for the implementation of the cerebrospinal fluid space, which has an at least medium needle penetration resistance N and a very low fluid penetration resistance F.

The medical simulators described here, in particular the medical simulator 2, improve the training of medical staff. In particular, they can be used to train epidural anaesthesia. It is particularly advantageous that both different needle penetration resistances N and different fluid penetration resistances F are simulated realistically and in a targeted manner. This improves the training effect.

1. A method for producing a medical simulator, having at least two foam components, wherein the method comprises the steps of:
additive manufacturing of a first foam component and
additive manufacturing of at least one further foam component, wherein the first foam component and the at least one further foam component are configured so as to have at least one of different foam structures and from different materials.

2. A method according to claim 1, wherein in that
at least one of the at least two foam components is configured so as to have at least one of a predetermined geometry of the elementary cells, orientation of the elementary cells, size of the elementary cells and cell wall structure.

3. The method according to claim 1, wherein in that
the first foam component and the at least one further foam component are configured so as to have different foam structures, wherein the different foam structures differ by at least one of the following foam structure parameters: geometry of the elementary cells, orientation of the elementary cells, average size of the elementary cells, pore structure and foam density.

4. The method according to claim 1, wherein
the first foam component and the at least one further foam component are manufactured from the same base material, with different additivation in each case.

5. The method according to claim 1,
additive manufacturing of a transition region between two adjacent foam components, wherein the transition region comprises a gradual transition between at least one of the different foam structures and materials of the adjacent foam components.

6. The method according to claim 1, wherein
the at least two foam components are manufactured integrally.

7. The method according to claim 1, wherein
at least one of the foam components is manufactured so as to have a foam structure in the form of a rod structure, wherein the edges of the elementary cells are formed by rods.

8. The method according to claim 1, wherein
the at least two foam components are adapted to a tissue structure of a patient.

9. A medical simulator, having at least two additively manufactured foam components, wherein the foam components differ in at least one of the following features: foam structure; and material.

10. The medical simulator according to claim 9, wherein
the foam structures of the first foam component and of the at least one further foam component differ by at least one of the following foam structure parameters: geometry of the elementary cells, orientation of the elementary cells, average size of the elementary cells, pore structure and foam density.

11. The medical simulator according to claim 9, wherein
the first foam component and the at least one further foam component have the same base material, with different additivation in each case.

12. The medical simulator according to claim 9, further comprising
a transition region between two adjacent foam components, wherein the transition region comprises a gradual transition between at least one of the different foam structures and materials of the adjacent foam components.

13. The medical simulator according to claim 9, wherein
at least one of the different foam structures has a rod structure, wherein the edges of the elementary cells are formed by rods.

14. The medical simulator according to claim 9, wherein
the at least two foam components are formed in one piece.

15. The medical simulator according to 9, wherein
at least one of the at least two foam components has at least one of a predetermined geometry of the elementary cells, orientation of the elementary cells, size of the elementary cells and cell wall structure.

16. A medical simulator method comprising the steps of:
providing a medical simulator having at least two additively manufactured foam components, wherein the foam components differ in at least one of the following features: foam structure and material; and
training medical staff with the simulator.

17. The method according to claim 16, wherein different needle penetration resistances and different fluid penetration resistances are simulated by means of the at least two foam components.

18. The method according to claim 1, wherein the medical simulator is an epidural anaesthesia simulator.

19. The method according to claim 2, wherein
at least one of the at least two foam components is manufactured so as to have at least one of a predetermined orientation of the elementary cells and size of the elementary cells.

20. The method according to claim 3, wherein the different foam structures differ by porosity.

21. The method according to claim 4, wherein the first foam component and the at least one further foam component are manufactured from the same base polymer, with different additivation in each case.

22. The medical simulator according to claim 9, wherein the medical simulator is an epidural anaesthesia simulator.

23. The medical simulator according to claim 10, wherein the foam structures of the first foam component and of the at least one further foam component differ by porosity.

24. The medical simulator according to claim 11, wherein
the first foam component and the at least one further foam component have the same base polymer, with different additivation in each case.

25. The medical simulator according to claim 15, wherein
at least one of the at least two foam components has at least one of a predetermined orientation of the elementary cells and size of the elementary cells.
